(19) United States
(12) Patent Application Publication
(10) Pub. No.: US 2011/0187649 A1
(43) Pub. Date: Aug. 4, 2011

(54) ELECTRONIC DEVICE

(76) Inventors: Chao-Ming CHU, Taipei (TW); Tzu-Wei Tai, Taipei (TW); Hsin-Ying Chen, Taipei (TW); Sheng-Ta Lin, Taipei (TW)

(21) Appl. No.: 13/015,212

(22) Filed: Jan. 27, 2011

(30) Foreign Application Priority Data
Jan. 29, 2010 (TW) 099102724

(51) Int. Cl. G06F 3/02

(52) U.S. Cl. 345/168

(57) ABSTRACT

An electronic device includes a host module and an input module. The input module includes a keyboard unit and a touch unit. The keyboard unit is electrically connected to the host module. The touch unit includes a touch pad and a plurality of key sets. The touch pad is electrically connected to the key sets. The key sets are selected to be disposed next to the touch pad or not. This can improve the flexibility for the user to use the electronic device with a touch pad and a plurality of key sets.

### CROSS REFERENCE TO RELATED APPLICATIONS

This Non-provisional application claims priority under 35 U.S.C. §119(a) on Patent Application No(s). 099102724 filed in Taiwan, Republic of China on Jan. 29, 2010, the entire contents of which are hereby incorporated by reference.

### BACKGROUND OF THE INVENTION

1. Field of Invention

The invention relates to an electronic device and, more particularly, to an electronic device having touch pads.

2. Related Art

With the development of the computer technology, the electronic device such as a notebook computer, a palmtop computer, a personal digital assistant (PDA), a global positioning system (GPS), an electronic book, an electronic dictionary, a game boy or a mobile communication device, are designed with powerful functions to meet the different requirements of the customers. Most of the electronic devices use the keyboards and/or the touch pads as the interface between the user and the device to input commands or execute control operations.

Taking the notebook computer as an example, FIG. 1 is a schematic diagram showing a conventional notebook computer 1. The notebook computer 1 includes a display screen 11, a host 12, a keyboard 13 and a touch unit 14. The display screen 11 is connected to the host 12. The keyboard 13 and the touch unit 14 are disposed at the host 12 and are connected to the host 12. The touch unit 14 is disposed below the keyboard 13 on the same plane. In general, the touch unit 14 includes a touch pad 141 and two keys 142 (functioned as the left and right keys of a mouse) for the user to perform input and control operations conveniently.

However, the keys 142 are almost disposed at the bottom of the touch pad 141. When the user uses the right hand to operate the touch pad 141, the left hand should place on the keys 142 in a hands-cross way. The conventional operating method does not meet the ergonomics, and it makes the user feel tired easily. Moreover, the configuration of the touch pad 141 and the keys 142 limit the operating way for users.

### SUMMARY OF THE INVENTION

The invention provides an ergonomic electronic device which can be operated more flexibly.

The electronic device includes a host module and an input module. The input module includes a keyboard unit and a touch unit. The keyboard unit is electrically connected to the host module. The touch unit includes a touch pad and a plurality of key sets. The touch pad is electrically connected to the key sets, and the key sets are selected to be disposed next to the touch pad or not.

In an embodiment, each of the key sets at least includes one key.

In an embodiment, the touch pad is disposed at one side of the keyboard unit, the key sets are disposed at two sides of the keyboard unit, and one of the key sets is disposed corresponding to the touch pad.

In an embodiment, the touch unit further includes a touch pad disposed adjacent to the keyboard unit and electrically connected to the host module.

As stated above, the input module of the electronic device includes a touch pad and a plurality of the key sets, the key sets can be disposed at any position of the input module, such as being selected to be disposed next to the touch pad or not. The user can operate the electronic device in different ways such as operating the touch pad and the key sets with single hand or both hands. When the user operates it with two hands, the left hand may operate the key sets, and the right hand operates the touch pad. The touch unit of the electronic device further includes another touch pad disposed adjacent to the keyboard unit. The user may operate one touch pad with the right hand, and operate the other touch pad with the left hand. Thus, the operating method of the electronic device is more flexible, and the key sets and the touch pad may be disposed at the two sides of the keyboard unit, respectively, for users to operate the key sets and the touch pad simultaneously with both hands. Thus, the structure of the electronic device meets the ergonomics, and the user would not feel tired easily after working for a long time.

These and other features, aspects and advantages of the present invention will become better understood with regard to the following description, appended claims, and accompanying drawings.

### BRIEF DESCRIPTION OF THE DRAWINGS

FIG. 1 is a schematic diagram showing a conventional notebook computer;

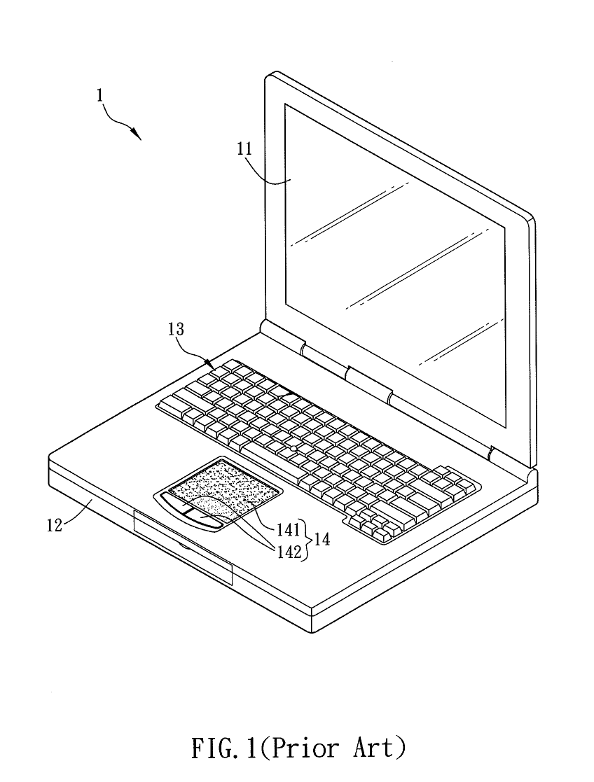

FIG. 2A is a schematic diagram showing an electronic device in a first embodiment;

FIG. 2B is a schematic diagram showing the electronic device in operating in the first embodiment;

FIG. 3 is a schematic diagram showing an electronic device in a second embodiment;

FIG. 4 is a schematic diagram showing an electronic device in a third embodiment;

FIG. 5 is a schematic diagram showing an electronic device in a fourth embodiment; and

FIG. 6 is a schematic diagram showing the electronic device in operating in the fourth embodiment.

### DETAILED DESCRIPTION OF THE INVENTION

An electronic device in preferable embodiments is illustrated referring to the relating figures. The same component numbers denote the same components.

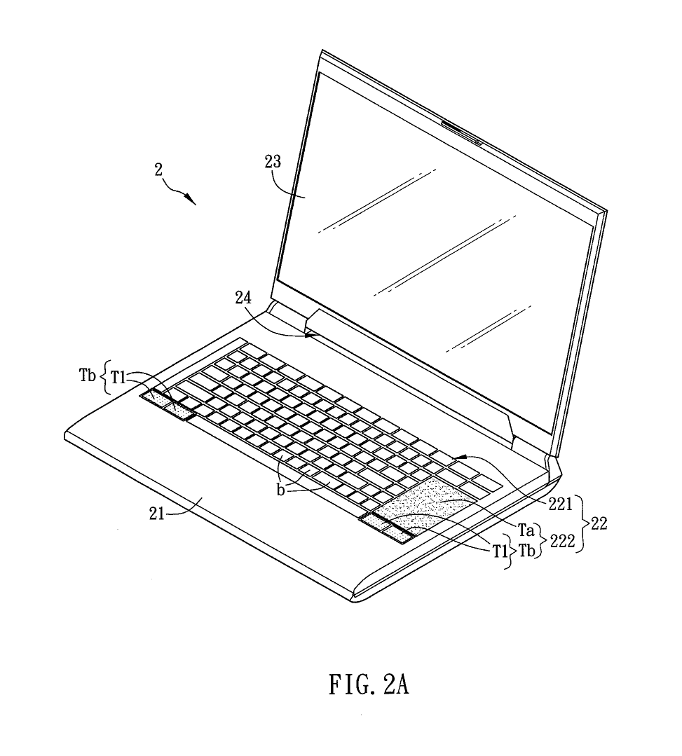

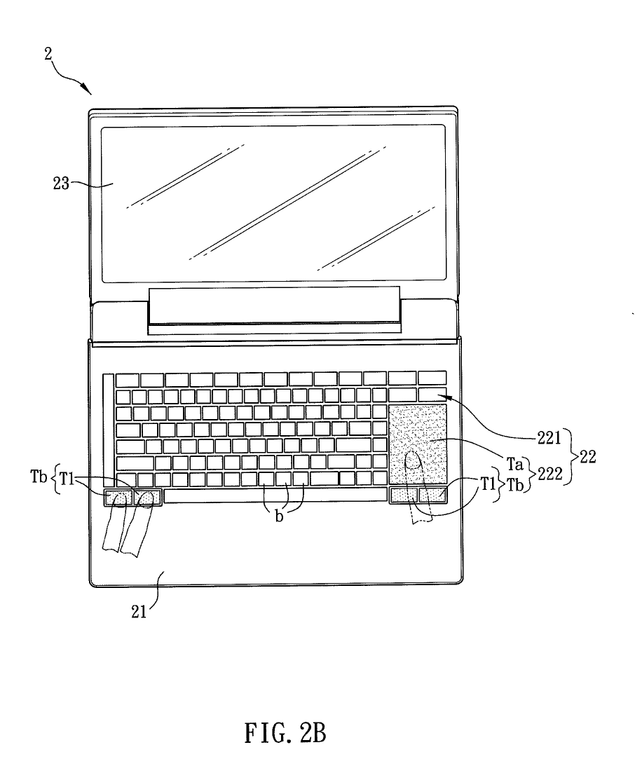

FIG. 2A is a schematic diagram showing an electronic device 2 in a first embodiment. The electronic device 2 may be a fixed electronic device or a portable electronic device. A portable electronic device may be a notebook computer, a palmtop computer, a personal digital assistant (PDA), a global positioning system (GPS), an electronic book, an electronic dictionary, a game boy or a mobile communication device. The notebook computer is taken as an example herein, and is not limited thereto.

The electronic device 2 includes a host module 21, an input module 22 and a display module 23. The input module 22 may be integrated into the host module 21 and the display module 23 to form a tablet computer with a function such as E-book.

In the embodiment, the host module 21 includes a motherboard (not shown), and the display module 23 may be a liquid crystal display (LCD) module. In the embodiment, the motherboard of the host module 21 is electrically connected to the display module 23 via wires (not shown) and a pivot 24, and is not limited thereto. The host module 21 and the display module 23 may be wiredly or wirelessly connected to the display module 23, and the connection therebetween may be electrical connection or signal connection.

The input module 22 includes a keyboard unit 221 and a touch unit 222. The keyboard unit 221 includes a plurality of keys b, and the keys b may be physical keys or virtual touch keys. Taking the physical keys as an example in the embodiment, the keys b are disposed at the host module 21 and electrically connected to the motherboard of the host module 21. Thus, the user uses the keys b to input words to control the electronic device 2.

The touch unit 222 includes a touch pad Ta and a plurality of key sets Tb. The touch pad Ta and the key sets Tb are disposed adjacent to the keyboard unit 221 and electrically connected to the host module 21, respectively.

In the embodiment, the touch pad Ta of the touch unit 222 is disposed at the host module 21, it is at a right side of the keyboard unit 221, and the touch pad Ta is electrically connected to the motherboard of the host module 21. The touch pad Ta also may be disposed at the upper side, the lower side or the left side of the keyboard unit 221, and is not limited thereto. The touch pad Ta may be a resistor touch pad or a capacitor touch pad, and the touch pad Ta also may be a single-point touch pad or a multi-point touch pad, and is not limited thereto.

The key sets Tb are electrically connected to the touch pad Ta. In the embodiment, for example, the touch unit 222 of the input module 22 includes two key sets Tb, and the two key sets Tb are electrically connected to the touch pad Ta, respectively, and is not limited thereto. The key sets Tb may be more than two according to the requirement.

The key sets Tb are disposed at the two sides of the keyboard unit 22, respectively, and the position of the key sets Tb are selected to be disposed next to the disposition of the touch pad Ta or not. In the embodiment, the key sets Tb at the right side of the keyboard unit 221 corresponds to the position of the touch pad Ta. The key sets Tb is at the lower side of the touch pad Ta.

Each of the key sets Tb at least includes one key T1. Taking the key sets Tb with two keys T1 as an example, the function of the keys T1 may be the same as that of the left and right keys of a mouse. The function of the keys T1, which may be the same as that of a mouse, may be changed by using a software control or a firmware. In other words, the software control or a firmware design method may be used to exchange the functions of the left key and the right key, or the keys T1 of the key sets Tb at one side only include the functions of a right key, and the keys T1 of the key sets Tb at the other side only include the functions of a left key. The key sets Tb may also include one or more than two keys T1, and the keys T1 may not be disposed at the lower side of the touch pad Ta.

When the user operates the electronic device 2, he or she can put one or two hands on the touch pad Ta at the right side and the key sets Tb to control the electronic device 2. As shown in FIG. 2B, the user may also put the left hand on the key sets Tb at the left side and put the right hand on the touch pad Ta at the right side to control the electronic device 2 simultaneously, which allows the user to operate the electronic device 2 in different modes and makes the operating method of the electronic device 2 more flexible. The operating method above is just an example, which is not limited herein.

Consequently, since the input module 22 of the electronic device 2 includes a touch pad Ta and a plurality of the key sets Tb, the key sets Tb may be disposed at any position of the input module 22 and selected to be disposed next to the disposition of the touch pad Ta or not. As a result, the user can operate the electronic device 2 in different operating method. For example, the user can operate the touch pad Ta and the key sets Tb simultaneously with one or two hands.

When the user operates the touch pad Ta and the key sets Tb with both hands, for example, he or she may operate the key sets Tb with the left hand and operate the touch pad Ta with the right hand. Thus, the operating method of the electronic device 2 is more flexible. The key sets Tb and the touch pad Ta may be disposed at the two sides of the keyboard unit 221, which allows the user to operate the key sets Tb and the touch pad Ta simultaneously with both hands. Consequently, the structure of the electronic device 2 meets the ergonomics, and the user would not feel tired easily after working for a long time.

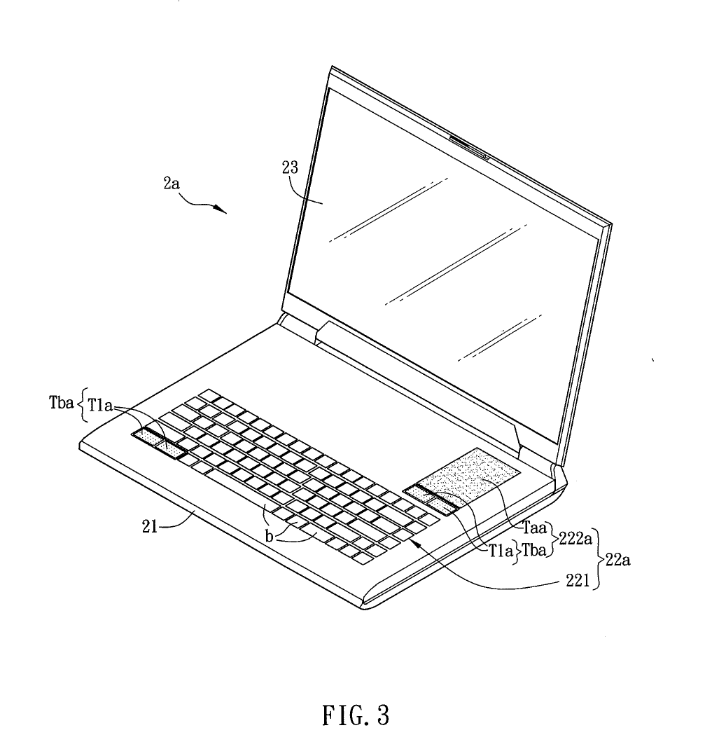

FIG. 3 is a schematic diagram showing an electronic device in a second embodiment. The difference between the electronic device 2a in the second embodiment and the electronic device 2 is that the key sets Tba of the electronic device 2a are disposed at the left side and the upper right side of the keyboard unit 221, respectively. The key sets Tba at the upper right side are disposed corresponding to the touch pad Taa. The key sets Tba also may include one or more than two keys T1a, and they also may be not disposed at the lower side of the touch pad Taa.

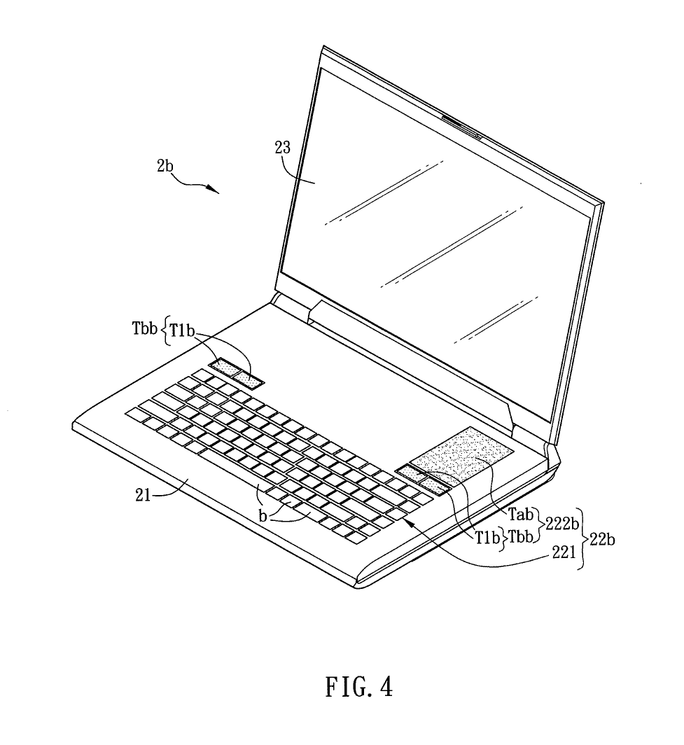

FIG. 4 is a schematic diagram showing an electronic device in a third embodiment. The difference between the electronic device 2b in the third embodiment and the electronic device 2 is that the key sets Tbb of the electronic device 2b are disposed at the upper left side and the upper right side of the keyboard unit 221, respectively. The key sets Tbb at the upper right side are disposed corresponding to the touch pad Tab. The key sets Tbb also may include one or more than two keys T1b, and they also may be not disposed at the lower side of the touch pad Tab.

The configurations and functions of the host module 21, the keyboard unit 221 and the display module 23 of the electronic devices 2a, 2b are the same as that of the electronic device 2, which are omitted herein for a concise purpose.

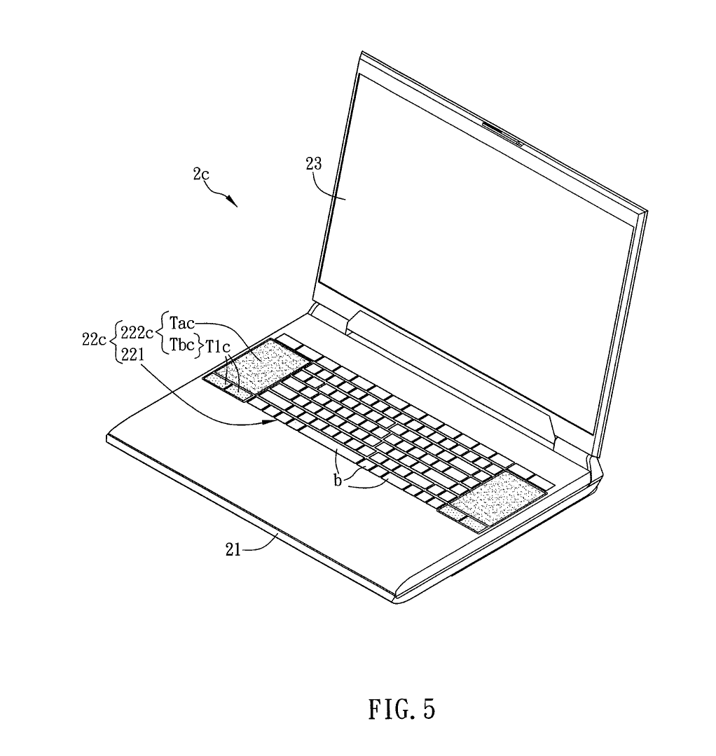

FIG. 5 is a schematic diagram showing an electronic device in a fourth embodiment. The difference between the electronic device 2c in the fourth embodiment and the electronic device 2 is that the touch unit 222c of the electronic device 2c further includes the other touch pad Tac disposed adjacent to the keyboard unit 221 and electrically connected to the host module 21. The touch pad Tac is disposed corresponding to another key sets Tbc.

Consequently, in the fourth embodiment, the electronic device 2c includes two touch pads Tac and two key sets Tbc, which are disposed at the two sides of the keyboard unit 221, respectively. The key sets Tbc at the two sides are disposed corresponding to the touch pad Tac and electrically connected to the corresponding touch pad Tac at the two sides, respectively. Each of the touch pads Tac may be a single-point touch pad or a multi-point touch pad, and the electronic device 2c may enable the single-point touch pads Tac at the two sides to include the multi-point touch function via a hardware device or a software control method.

Each of the touch pads Tac may operate independently, or the two touch pads Tac operate together to achieve the function such as the multi-point touch function. In other words, each of the touch pads Tac of the electronic device 2c in the embodiment may be a single-point touch pad, and the user can operate the touch pads Tac with two hands, respectively. Thus, the electronic device 2c includes the function similar to the multi-point touch function.

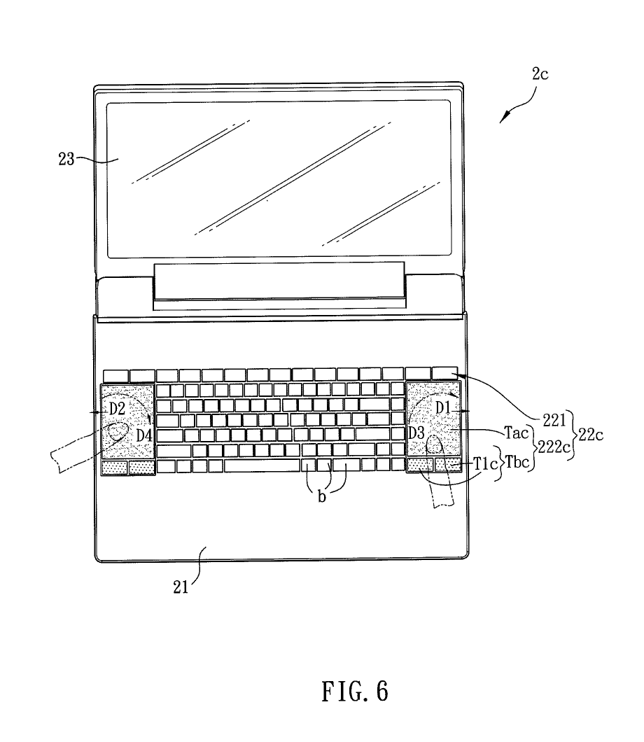

As shown in FIG. 6, when the user moves his or her hands towards the directions D1 and D2, respectively, the electronic device 2 controls the display to zoom in. When the user moves his or her hands against the directions D1 and D2, respectively, the electronic device 2 controls the display to zoom out. When the user moves his or her hands towards the directions D3 and D4, respectively, the electronic device 2 controls the display object to rotate. The function and the control method are just examples, which may be updated or modified by a firmware or software, and is not limited thereto. The touch pads Tac also may include the multi-point touch function, and the user may operate the single touch pad Tac with the left hand or the right hand to achieve the multi-point control. The user also may operate the two touch pads Tac simultaneously to achieve the multi-point control with more functions. The control method is not limited herein.

In summary, the input module of the electronic device includes a touch pad and a plurality of the key sets, and the key sets may be disposed at any position of the input module and are selected to be disposed next to the disposition of the touch pad or not. The user can operate the electronic device in different operating methods, for example, the user may operate the touch pad and the key sets simultaneously with one hand, or operate the touch pad and the key sets, respectively, with both hands. The user may operate the touch pad and the key sets with both hands, for example, the user operates the key sets with the left hand and operates the touch pad with the right hand. Moreover, the touch unit of the electronic device may further include another touch pad disposed adjacent to the keyboard unit. The user may operate a touch pad with the right hand, and operate a touch pad with the left hand. Thus, the operating method of the electronic device is more flexible, and the key sets and the touch pad may be disposed at the two sides of the keyboard unit, respectively, to allow the user to operate the key sets and the touch pad simultaneously. The structure of the electronic device meets the ergonomics, and the user would not feel tired easily after working for a long time.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. An electronic device, comprising:
a host module; and
an input module, including:
a keyboard unit electrically connected to the host module; and
a touch unit electrically connected to the host module, wherein the touch unit includes a touch pad and a plurality of key sets, the touch pad is electrically connected to the key sets, and the key sets are selected to be disposed next to the touch pad or not.

2. The electronic device according to claim 1, wherein the touch pad is a single-point touch pad or a multi-point touch pad.

3. The electronic device according to claim 1, wherein the touch pad is a resistor touch pad or a capacitor touch pad.

4. The electronic device according to claim 1, wherein each of the key sets at least includes one key.

5. The electronic device according to claim 1, wherein the touch pad is disposed at one side of the keyboard unit, the key sets are disposed at two sides of the keyboard unit, and one of the key sets is disposed corresponding to the touch pad.

6. The electronic device according to claim 1, wherein the function of the key sets is the same as control functions of the left and right keys of a mouse.

7. The electronic device according to claim 1, further comprising a display module electrically connected to the host module.

8. The electronic device according to claim 1, wherein the touch unit further comprises a touch pad disposed adjacent to the keyboard unit and electrically connected to the host module.

9. The electronic device according to claim 1, which is a notebook computer, a palmtop computer, a personal digital assistant (PDA), a global positioning system (GPS), an electronic book, an electronic dictionary, a game boy or a mobile communication device.
